(19) United States
(12) Patent Application Publication
(10) Pub. No.: US 2025/0113286 A1
(43) Pub. Date: Apr. 3, 2025

(54) Enhanced Overload and Congestion Control in Wireless Communication Systems

(71) Applicant: Apple Inc., Cupertino, CA (US)

(72) Inventors: Behrouz Aghili, San Diego, CA (US); Sudeep Manithara Vamanan, Munich (DE); Krisztian Kiss, Hayward, CA (US)

(21) Appl. No.: 18/778,093

(22) Filed: Jul. 19, 2024

Related U.S. Application Data
(60) Provisional application No. 63/586,464, filed on Sep. 29, 2023.

(51) Int. Cl. H04W 48/06; H04W 28/02; H04W 60/06

(52) U.S. Cl. CPC H04W 48/06; H04W 28/0289; H04W 60/06

(57) ABSTRACT

A processor comprising memory storing instructions that, when executed, cause the processor to establish a fifth generation (5G) connection associated with a next-generation node-B (gNB) and an access and mobility function (AMF). Additionally, the processor can transmit, based at least in part on a loss of the 5G connection, a connection request message to an enhanced node-B (eNB) and receive, from the eNB, a connection reject message. The connection reject message can include an indication associated with a timer expiry value and the processor can start a timer in accordance with the timer expiry value. The processor can further determine a period of unavailability of a user equipment (UE), transmit a request message indicating the period of unavailability to the AMF, and receive a response message from the AMF.

### PRIORITY INFORMATION

This application claims priority to U.S. Provisional Patent Application No. 63/586,464, entitled “Enhanced Overload and Congestion Control in Wireless Communication Systems,” filed Sep. 29, 2023, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The invention relates to wireless communications, and more particularly to apparatuses, systems, and methods for enhanced overload and congestion control in wireless communication systems.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include LTE, LTE Advanced (LTE-A), HSPA, IEEE 802.11 (WLAN or Wi-Fi), BLUETOOTH™, ultra-wideband (UWB), etc.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development.

A proposed next telecommunications standard moving beyond the current International Mobile Telecommunications-Advanced (IMT-Advanced) Standards is called 5th generation mobile networks or 5th generation wireless systems, or 5G for short (otherwise known as 5G-NR for 5G New Radio, also simply referred to as NR). 5G-NR proposes a higher capacity for a higher density of mobile broadband users, also supporting device-to-device, ultra-reliable, and massive machine communications, as well as lower latency and lower battery consumption, than current LTE standards. Further, the 5G-NR standard can allow for less restrictive UE scheduling as compared to current LTE standards. Consequently, efforts are being made in ongoing developments of 5G-NR to take advantage of higher throughputs possible at higher frequencies. Accordingly, improvements in the field in support of such development and design are desired.

### SUMMARY

Embodiments relate to wireless communications, and more particularly to apparatuses, systems, and methods for enhanced overload and congestion control in wireless communication systems.

According to some embodiments, a processor comprising memory storing instructions that, when executed, cause the processor to establish a fifth generation (5G) connection associated with a next-generation node-B (gNB) and an access and mobility function (AMF). Additionally, the processor can generate, for transmission to an enhanced node-B (eNB) and based at least in part on a loss of the 5G connection, a connection request message and receive, from the eNB, a connection reject message. The connection reject message can include an indication associated with a timer expiry value and the processor can start a timer in accordance with the timer expiry value. The processor can further determine a period of unavailability of a user equipment (UE), generate a request message indicating the period of unavailability for transmission to the AMF, and receive a response message from the AMF.

In some embodiments, the connection request message and connection reject message can be radio resource control (RRC) messages. Additionally or alternatively, the request message can be a service request message, a registration request message, or a de-registration request message. Furthermore, the connection reject message from the eNB can be received by the processor at least partially due to a condition of overload or congestion at a mobility management entity (MME).

According to further embodiments, the response message can be transmitted by the AMF based at least in part on a determination made by the AMF and can be a service accept message, a service reject message, a registration accept message, a registration reject message, a de-registration accept message. Additionally or alternatively, the determination can be based on a processing load of the AMF.

In some embodiments, the indication can be an information element (IE) added to the request message, a code-point in a message type IE, or a flag. Additionally or alternatively, the timer can be a T3346 timer and the timer expiry value can be an extended wait time (EWT). In some embodiments, the request message can be for a fifth generation (5G) cell in a same registration area including a cell that the UE was previously connected to. Additionally or alternatively, the response message can include a new timer expiry value determined by the AMF. According to some embodiments, the connection reject message can be received at a radio resource control (RRC) layer of the UE.

In some embodiments, the request message can be for a fifth generation (5G) cell in a second registration area different from a first registration area that includes a cell that the UE was previously connected to. Additionally or alternatively, the request message can be one of a registration request message, a de-registration request message, or a non-access stratum (NAS) message.

In some embodiments, a method can include establishing a fifth generation (5G) connection associated with a next-generation node-B (gNB) and an access and mobility function (AMF). Additionally, the method can include transmitting, based at least in part on a loss of the 5G connection, a connection request message to an enhanced node-B (eNB) and receiving, from the eNB, a connection reject message. The connection reject message can include an indication associated with a timer expiry value and the method can include starting a timer in accordance with the timer expiry value. The method can further include determining a period of unavailability of a user equipment (UE), transmitting a request message indicating the period of unavailability to the AMF, and receiving a response message from the AMF. According to some embodiments, the method can be performed by a non-transitory computer readable storage medium storing program instructions executable by one or more processors to perform the method.

The techniques described herein can be implemented in and/or used with a number of different types of devices, including but not limited to unmanned aerial vehicles (UAVs), unmanned aerial controllers (UACs), base stations, access points, cellular phones, tablet computers, wearable computing devices, portable media players, automobiles and/or motorized vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a user equipment (UE), according to some embodiments;

FIG. 4 illustrates an example block diagram of a BS, according to some embodiments;

FIG. 5 illustrates an example block diagram of cellular communication circuitry, according to some embodiments;

FIG. 6A illustrates an example of connections between an EPC network, an LTE base station (eNB), and a 5G NR base station (gNB), according to some embodiments;

FIG. 6B illustrates an example of a protocol stack for an eNB and a gNB, according to some embodiments;

FIG. 7 illustrates an example of a baseband processor architecture for a UE, according to some embodiments; and

FIG. 8 is a communication flow diagram illustrating example aspects of a method for enhanced overload and congestion control, according to some embodiments.

While the features described herein can be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
3GPP: Third Generation Partnership Project
TS: Technical Specification
RAN: Radio Access Network
RAT: Radio Access Technology
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC: 5G Core Network
4G: Fourth Generation
5G: Fifth Generation
eNB: Enhanced Node-B
gNB: Next Generation Node-B
IE: Information Element
RRC: Radio Resource Control
MAC: Media Access Control
RLC: Radio Link Control
NW: Network
NAS: Non-Access Stratum
EPS: Evolved Packet System
MTC: Machine Type Communication
CIoT: Cellular Internet of Things
MM: Mobility Management
SM: Session Management
MME: Mobility Management Entity
RAN: Radio Access Network
EWT: Extended Wait Time
EMM: EPS Mobility Management
SUECR: Seamless UE Context Recovery
SW: Software
AMF: Access and Mobility Function

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, other handheld devices, automobiles and/or motor vehicles, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by (or with) a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” can differ according to different wireless protocols, the term “channel” as used herein can be considered as being used in a manner that is consistent with the standard of the type of device with reference to which the term is used. In some standards, channel widths can be variable (e.g., depending on device capability, band conditions, etc.). For example, LTE can support scalable channel bandwidths from 1.4 MHz to 20 MHz. In contrast, WLAN channels can be 22 MHz wide while Bluetooth channels can be 1 Mhz wide. Other protocols and standards can include different definitions of channels. Furthermore, some standards can define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.

Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

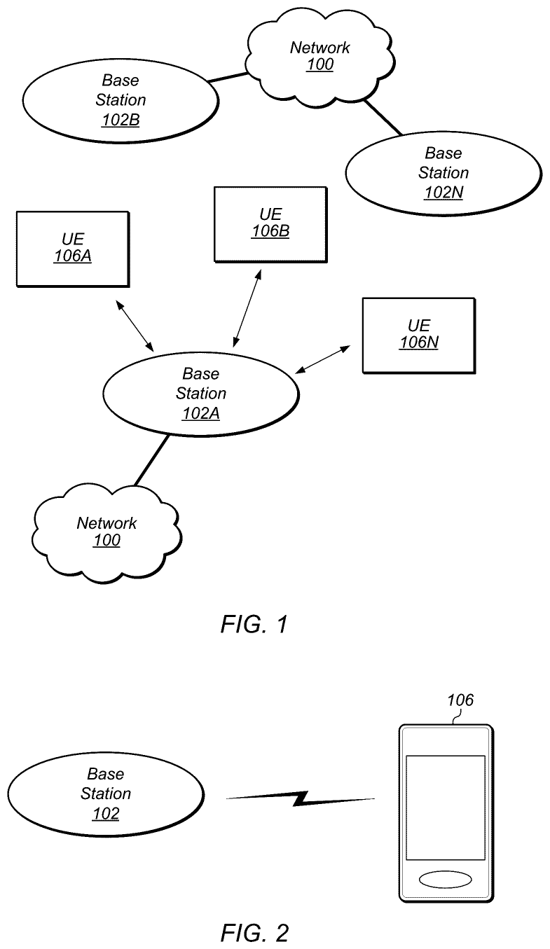

### FIGS. 1 and 2—Communication System

FIG. 1 illustrates a simplified example wireless communication system, according to some embodiments. It is noted that the system of FIG. 1 is merely one example of a possible system, and that features of this disclosure can be implemented in any of various systems, as desired.

As shown, the example wireless communication system includes a base station 102A which communicates over a transmission medium with one or more user devices 106A, 106B, etc., through 106N. Each of the user devices can be referred to herein as a “user equipment” (UE). Thus, the user devices 106 are referred to as UEs or UE devices.

The base station (BS) 102A can be a base transceiver station (BTS) or cell site (a “cellular base station”), and can include hardware that enables wireless communication with the UEs 106A through 106N.

The communication area (or coverage area) of the base station can be referred to as a “cell.” The base station 102A and the UEs 106 can be configured to communicate over the transmission medium using any of various radio access technologies (RATs), also referred to as wireless communication technologies, or telecommunication standards, such as LTE, LTE-Advanced (LTE-A), 5G new radio (5G NR), HSPA, UWB, etc. Note that if the base station 102A is implemented in the context of LTE, it can alternately be referred to as an ‘eNodeB’ or ‘eNB’. Note that if the base station 102A is implemented in the context of 5G NR, it can alternately be referred to as ‘gNodeB’ or ‘gNB’.

As shown, the base station 102A can also be equipped to communicate with a network 100 (e.g., a core network of a cellular service provider, a telecommunication network such as a public switched telephone network (PSTN), and/or the Internet, among various possibilities). Thus, the base station 102A can facilitate communication between the user devices and/or between the user devices and the network 100. In particular, the cellular base station 102A can provide UEs 106 with various telecommunication capabilities, such as voice, SMS and/or data services.

Base station 102A and other similar base stations (such as base stations 102B . . . 102N) operating according to the same or a different cellular communication standard can thus be provided as a network of cells, which can provide continuous or nearly continuous overlapping service to UEs 106A-N and similar devices over a geographic area via one or more cellular communication standards.

Thus, while base station 102A can act as a “serving cell” for UEs 106A-N as illustrated in FIG. 1, each UE 106 can also be capable of receiving signals from (and possibly within communication range of) one or more other cells (which might be provided by base stations 102B-N and/or any other base stations), which can be referred to as “neighboring cells”. Such cells can also be capable of facilitating communication between user devices and/or between user devices and the network 100. Such cells can include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A can be a next generation base station, e.g., a 5G New Radio (5G NR) base station, or “gNB”. In some embodiments, a gNB can be connected to a legacy evolved packet core (EPC) network and/or to a NR core (NRC) network. In addition, a gNB cell can include one or more transition and reception points (TRPs). In addition, a UE capable of operating according to 5G NR can be connected to one or more TRPs within one or more gNBs.

Note that a UE 106 can be capable of communicating using multiple wireless communication standards. For example, the UE 106 can be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., LTE, LTE-A, 5G NR, HSPA, UWB, etc.). The UE 106 can also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 can be a device with cellular communication capability such as a mobile phone, a hand-held device, a computer or a tablet, or virtually any type of wireless device.

The UE 106 can include a processor that is configured to execute program instructions stored in memory. The UE 106 can perform any of the method embodiments described herein by executing such stored instructions. Alternatively, or in addition, the UE 106 can include a programmable hardware element such as an FPGA (field-programmable gate array) that is configured to perform any of the method embodiments described herein, or any portion of any of the method embodiments described herein.

The UE 106 can include one or more antennas for communicating using one or more wireless communication protocols or technologies. In some embodiments, the UE 106 can be configured to communicate using, for example, LTE using a single shared radio. The shared radio can couple to a single antenna, or can couple to multiple antennas (e.g., for MIMO) for performing wireless communications. In general, a radio can include any combination of a baseband processor, analog RF signal processing circuitry (e.g., including filters, mixers, oscillators, amplifiers, etc.), or digital processing circuitry (e.g., for digital modulation as well as other digital processing). Similarly, the radio can implement one or more receive and transmit chains using the aforementioned hardware. For example, the UE 106 can share one or more parts of a receive and/or transmit chain between multiple wireless communication technologies, such as those discussed above.

In some embodiments, the UE 106 can include separate transmit and/or receive chains (e.g., including separate antennas and other radio components) for each wireless communication protocol with which it is configured to communicate. As a further possibility, the UE 106 can include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT), and separate radios for communicating using each of Wi-Fi and Bluetooth. Other configurations are also possible.

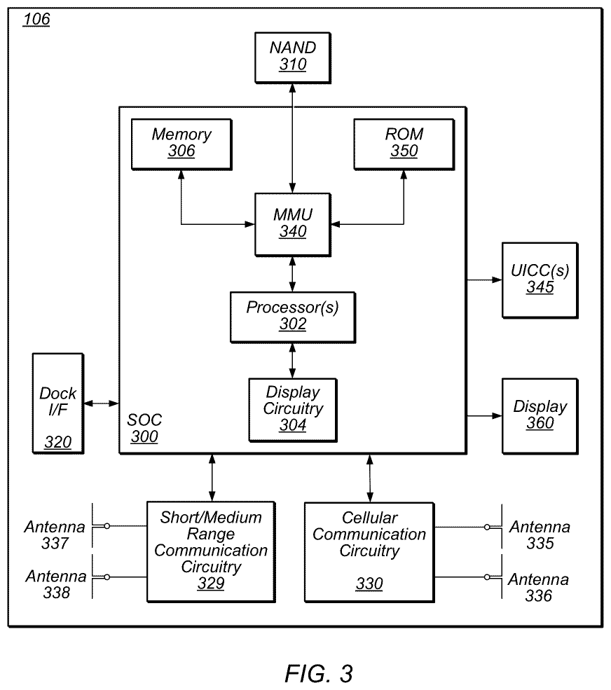

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 can be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 can include a set of components 300 configured to perform core functions. For example, this set of components can be implemented as a system on chip (SOC), which can include portions for various purposes. Alternatively, this set of components 300 can be implemented as separate components or groups of components for the various purposes. The set of components 300 can be coupled (e.g., communicatively; directly or indirectly) to various other circuits of the communication device 106.

For example, the communication device 106 can include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which can be integrated with or external to the communication device 106, and cellular communication circuitry 330 such as for 5G NR, LTE, etc., and short to medium range wireless communication circuitry 329 (e.g., Bluetooth™ and WLAN circuitry). In some embodiments, communication device 106 can include wired communication circuitry (not shown), such as a network interface card, e.g., for Ethernet.

The cellular communication circuitry 330 can couple (e.g., communicatively; directly or indirectly) to one or more antennas, such as antennas 335 and 336 as shown. The short to medium range wireless communication circuitry 329 can also couple (e.g., communicatively; directly or indirectly) to one or more antennas, such as antennas 337 and 338 as shown. Alternatively, the short to medium range wireless communication circuitry 329 can couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 can include multiple receive chains and/or multiple transmit chains for receiving and/or transmitting multiple spatial streams, such as in a multiple-input multiple output (MIMO) configuration.

In some embodiments, as further described below, cellular communication circuitry 330 can include dedicated receive chains including and/or coupled to (e.g., communicatively, directly or indirectly). Dedicated processors and/or radios for multiple RATs (e.g., a first receive chain for LTE and a second receive chain for 5G NR). In addition, in some embodiments, cellular communication circuitry 330 can include a single transmit chain that can be switched between radios dedicated to specific RATs. For example, a first radio can be dedicated to a first RAT, e.g., LTE, and can be in communication with a dedicated receive chain and a transmit chain shared with an additional radio, e.g., a second radio that can be dedicated to a second RAT, e.g., 5G NR, and can be in communication with a dedicated receive chain and the shared transmit chain.

The communication device 106 can also include and/or be configured for use with one or more user interface elements. The user interface elements can include any of various elements, such as display 360 (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input.

The communication device 106 can further include one or more smart cards 345 that include SIM (Subscriber Identity Module) functionality, such as one or more UICC(s) (Universal Integrated Circuit Card(s)) cards 345.

As shown, the SOC 300 can include processor(s) 302, which can execute program instructions for the communication device 106 and display circuitry 304, which can perform graphics processing and provide display signals to the display 360. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 can be configured to perform memory protection and page table translation or set up. In some embodiments, the MMU 340 can be included as a portion of the processor(s) 302.

As noted above, the communication device 106 can be configured to communicate using wireless and/or wired communication circuitry. The communication device 106 can be configured to transmit a request to attach to a first network node operating according to the first RAT and transmit an indication that the wireless device is capable of maintaining substantially concurrent connections with the first network node and a second network node that operates according to the second RAT. The wireless device can also be configured transmit a request to attach to the second network node. The request can include an indication that the wireless device is capable of maintaining substantially concurrent connections with the first and second network nodes. Further, the wireless device can be configured to receive an indication that dual connectivity with the first and second network nodes has been established.

As described herein, the communication device 106 can include hardware and software components for implementing the above features for time division multiplexing UL data for NSA NR operations. The processor 302 of the communication device 106 can be configured to implement part or all of the features described herein, e.g., by executing program instructions stored on a memory medium (e.g., a non-transitory computer-readable memory medium). Alternatively (or in addition), processor 302 can be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 can be configured to implement part or all of the features described herein.

In addition, as described herein, processor 302 can include one or more processing elements. Thus, processor 302 can include one or more integrated circuits (ICs) that are configured to perform the functions of processor 302. In addition, each integrated circuit can include circuitry (e.g., first circuitry, second circuitry, etc.) configured to perform the functions of processor(s) 302.

Further, as described herein, cellular communication circuitry 330 and short range wireless communication circuitry 329 can each include one or more processing elements. For example, one or more processing elements can be included in cellular communication circuitry 330 and, similarly, one or more processing elements can be included in short range wireless communication circuitry 329. Thus, cellular communication circuitry 330 can include one or more integrated circuits (ICs) that are configured to perform the functions of cellular communication circuitry 330. In addition, each integrated circuit can include circuitry (e.g., first circuitry, second circuitry, etc.) configured to perform the functions of cellular communication circuitry 230. Similarly, the short range wireless communication circuitry 329 can include one or more ICs that are configured to perform the functions of short range wireless communication circuitry 32. In addition, each integrated circuit can include circuitry (e.g., first circuitry, second circuitry, etc.) configured to perform the functions of short range wireless communication circuitry 329.

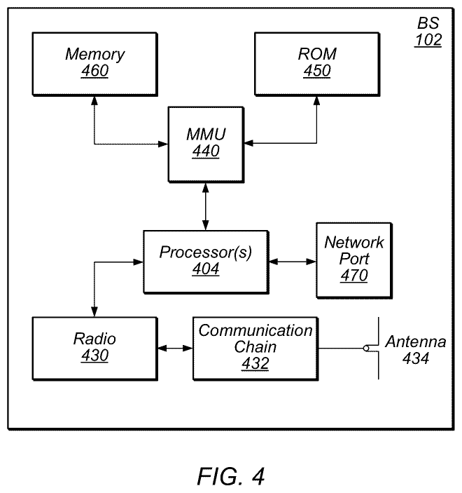

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 can include processor(s) 404 which can execute program instructions for the base station 102. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

The base station 102 can include at least one network port 470. The network port 470 can be configured to couple to a telephone network and provide a plurality of devices, such as UE devices 106, access to the telephone network as described above in FIGS. 1 and 2.

The network port 470 (or an additional network port) can also or alternatively be configured to couple to a cellular network, e.g., a core network of a cellular service provider. The core network can provide mobility related services and/or other services to a plurality of devices, such as UE devices 106. In some cases, the network port 470 can couple to a telephone network via the core network, and/or the core network can provide a telephone network (e.g., among other UE devices serviced by the cellular service provider).

In some embodiments, base station 102 can be a next generation base station, e.g., a 5G New Radio (5G NR) base station, or “gNB”. In such embodiments, base station 102 can be connected to a legacy evolved packet core (EPC) network and/or to a NR core (NRC) network. In addition, base station 102 can be considered a 5G NR cell and can include one or more transmission and reception points (TRPs). In addition, a UE capable of operating according to 5G NR can be connected to one or more TRPs within one or more gNBs.

The base station 102 can include at least one antenna 434, and possibly multiple antennas. The at least one antenna 434 can be configured to operate as a wireless transceiver and can be further configured to communicate with UE devices 106 via radio 430. The antenna 434 communicates with the radio 430 via communication chain 432. Communication chain 432 can be a receive chain, a transmit chain or both. The radio 430 can be configured to communicate via various wireless communication standards, including, but not limited to, 5G NR, LTE, LTE-A, Wi-Fi, UWB, etc.

The base station 102 can be configured to communicate wirelessly using multiple wireless communication standards. In some instances, the base station 102 can include multiple radios, which can enable the base station 102 to communicate according to multiple wireless communication technologies. For example, as one possibility, the base station 102 can include an LTE radio for performing communication according to LTE as well as a 5G NR radio for performing communication according to 5G NR. In such a case, the base station 102 can be capable of operating as both an LTE base station and a 5G NR base station. As another possibility, the base station 102 can include a multi-mode radio which is capable of performing communications according to any of multiple wireless communication technologies (e.g., 5G NR and Wi-Fi, LTE and Wi-Fi, LTE, UWB, etc.).

As described further subsequently herein, the BS 102 can include hardware and software components for implementing or supporting implementation of features described herein. The processor 404 of the base station 102 can be configured to implement or support implementation of part or all of the methods described herein, e.g., by executing program instructions stored on a memory medium (e.g., a non-transitory computer-readable memory medium). Alternatively, the processor 404 can be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 can be configured to implement or support implementation of part or all of the features described herein.

In addition, as described herein, processor(s) 404 can be comprised of one or more processing elements. For example, one or more processing elements can be included in processor(s) 404. Thus, processor(s) 404 can include one or more integrated circuits (ICs) that are configured to perform the functions of processor(s) 404. In addition, each integrated circuit can include circuitry (e.g., first circuitry, second circuitry, etc.) configured to perform the functions of processor(s) 404.

Further, as described herein, radio 430 can be comprised of one or more processing elements. For example, one or more processing elements can be included in radio 430. Thus, radio 430 can include one or more integrated circuits (ICs) that are configured to perform the functions of radio 430. In addition, each integrated circuit can include circuitry (e.g., first circuitry, second circuitry, etc.) configured to perform the functions of radio 430.

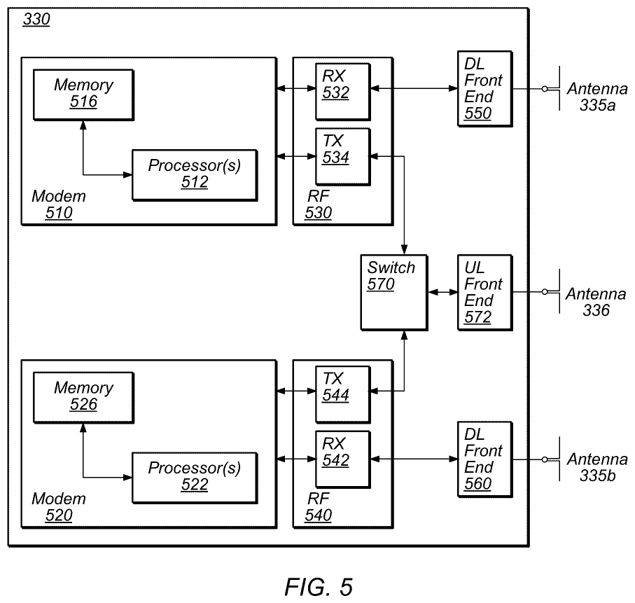

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which can be cellular communication circuitry 430, can be included in a communication device, such as communication device 106 described above. As noted above, communication device 106 can be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 can couple (e.g., communicatively; directly or indirectly) to one or more antennas, such as antennas 435a-b and 436 as shown (in FIG. 4). In some embodiments, cellular communication circuitry 530 can include dedicated receive chains including and/or coupled to (e.g., communicatively, directly or indirectly) dedicated processors and/or radios for multiple RATs (e.g., a first receive chain for LTE and a second receive chain for 5G NR). For example, as shown in FIG. 5, cellular communication circuitry 530 can include a modem 510 and a modem 520. Modem 510 can be configured for communications according to a first RAT, e.g., such as LTE or LTE-A, and modem 520 can be configured for communications according to a second RAT, e.g., such as 5G NR.

As shown, modem 510 can include one or more processors 512 and a memory 516 in communication with processors 512. Modem 510 can be in communication with a radio frequency (RF) front end 530. RF front end 530 can include circuitry for transmitting and receiving radio signals. For example, RF front end 530 can include receive circuitry (RX) 532 and transmit circuitry (TX) 534. In some embodiments, receive circuitry 532 can be in communication with downlink (DL) front end 550, which can include circuitry for receiving radio signals via antenna 335a.

Similarly, modem 520 can include one or more processors 522 and a memory 526 in communication with processors 522. Modem 520 can be in communication with an RF front end 540. RF front end 540 can include circuitry for transmitting and receiving radio signals. For example, RF front end 540 can include receive circuitry 542 and transmit circuitry 544. In some embodiments, receive circuitry 542 can be in communication with DL front end 560, which can include circuitry for receiving radio signals via antenna 335b.

In some embodiments, a switch 570 can couple transmit circuitry 534 to uplink (UL) front end 572. In addition, switch 570 can couple transmit circuitry 544 to UL front end 572. UL front end 572 can include circuitry for transmitting radio signals via antenna 336. Thus, when cellular communication circuitry 530 receives instructions to transmit according to the first RAT (e.g., as supported via modem 510), switch 570 can be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 can be switched to a second state that allows modem 520 to transmit signals according to the second RAT (e.g., via a transmit chain that includes transmit circuitry 544 and UL front end 572).

In some embodiments, the cellular communication circuitry 530 can be configured to perform methods of beam failure recovery based on a unified transmission configuration indicator (TCI) framework, e.g., in 5G NR systems and beyond, as further described herein. For example, TCI frameworks can be characterized by TCI states that are dynamically sent via DCI which can include quasi-colocation (QCL) relationships between downlink reference signals in a channel state information reference signal (CSI-RS) set and physical downlink shared channel (PDSCH) demodulation reference signal (DMRS) ports, according to some embodiments.

As described herein, the modem 510 can include hardware and software components for implementing the above features or for time division multiplexing UL data for NSA NR operations, as well as the various other techniques described herein. The processors 512 can be configured to implement part or all of the features described herein, e.g., by executing program instructions stored on a memory medium (e.g., a non-transitory computer-readable memory medium). Alternatively (or in addition), processor 512 can be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 can be configured to implement part or all of the features described herein.

In addition, as described herein, processors 512 can include one or more processing elements. Thus, processors 512 can include one or more integrated circuits (ICs) that are configured to perform the functions of processors 512. In addition, each integrated circuit can include circuitry (e.g., first circuitry, second circuitry, etc.) configured to perform the functions of processors 512.

As described herein, the modem 520 can include hardware and software components for implementing the above features for communicating a scheduling profile for power savings to a network, as well as the various other techniques described herein. The processors 522 can be configured to implement part or all of the features described herein, e.g., by executing program instructions stored on a memory medium (e.g., a non-transitory computer-readable memory medium). Alternatively (or in addition), processor 522 can be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 can be configured to implement part or all of the features described herein.

In addition, as described herein, processors 522 can include one or more processing elements. Thus, processors 522 can include one or more integrated circuits (ICs) that are configured to perform the functions of processors 522. In addition, each integrated circuit can include circuitry (e.g., first circuitry, second circuitry, etc.) configured to perform the functions of processors 522.

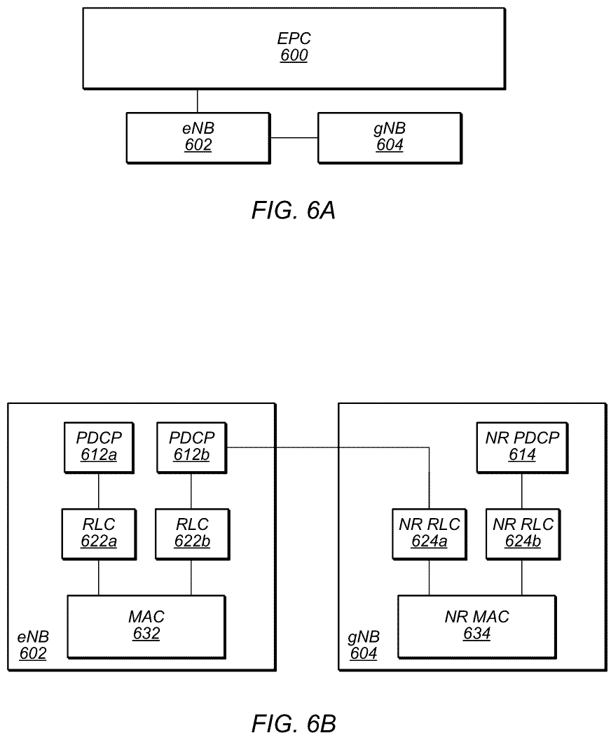

### FIGS. 6A and 6B: 5G NR Architecture with LTE

In some implementations, fifth generation (5G) wireless communication can initially be deployed concurrently with other wireless communication standards (e.g., LTE). For example, dual connectivity between LTE and 5G new radio (5G NR or NR) has been specified as part of the initial deployment of NR. Thus, as illustrated in FIGS. 6A-B, evolved packet core (EPC) network 600 can continue to communicate with current LTE base stations (e.g., eNB 602). In addition, eNB 602 can be in communication with a 5G NR base station (e.g., gNB 604) and can pass data between the EPC network 600 and gNB 604. Thus, EPC network 600 can be used (or reused) and gNB 604 can serve as extra capacity for UEs, e.g., for providing increased downlink throughput to UEs. For example, LTE can be used for control plane signaling and NR can be used for user plane signaling. Thus, LTE can be used to establish connections to the network and NR can be used for data services.

FIG. 6B illustrates a proposed protocol stack for eNB 602 and gNB 604. As shown, eNB 602 can include a medium access control (MAC) layer 632 that interfaces with radio link control (RLC) layers 622a-b. RLC layer 622a can also interface with packet data convergence protocol (PDCP) layer 612a and RLC layer 622b can interface with PDCP layer 612b. Similar to dual connectivity as specified in LTE-Advanced Release 12, PDCP layer 612a can interface via a master cell group (MCG) bearer with EPC network 600 whereas PDCP layer 612b can interface via a split bearer with EPC network 600.

Additionally, as shown, gNB 604 can include a MAC layer 634 that interfaces with RLC layers 624a-b. RLC layer 624a can interface with PDCP layer 612b of eNB 602 via an X2 interface for information exchange and/or coordination (e.g., scheduling of a UE) between eNB 602 and gNB 604. In addition, RLC layer 624b can interface with PDCP layer 614. Similar to dual connectivity as specified in LTE-Advanced Release 12, PDCP layer 614 can interface with EPC network 600 via a secondary cell group (SCG) bearer. Thus, eNB 602 can be considered a master node (MeNB) while gNB 604 can be considered a secondary node (SgNB). In some scenarios, a UE can be required to maintain a connection to both an MeNB and a SgNB. In such scenarios, the MeNB can be used to maintain a radio resource control (RRC) connection to an EPC while the SgNB can be used for capacity (e.g., additional downlink and/or uplink throughput).

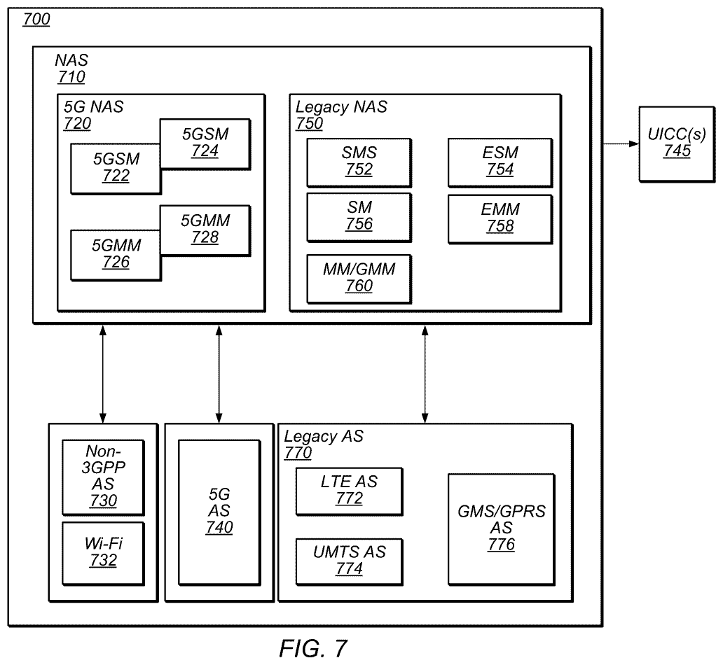

### FIG. 7: UE Baseband Processor Architecture

FIG. 7 illustrates an example of a baseband processor architecture for a UE (e.g., such as UE 106), according to some embodiments. The baseband processor architecture 700 described in FIG. 7 can be implemented on one or more radios (e.g., radios 329 and/or 330 described above) or modems (e.g., modems 510 and/or 520) as described above. As shown, the non-access stratum (NAS) 710 can include a 5G NAS 720 and a legacy NAS 750. The legacy NAS 750 can include a communication connection with a legacy access stratum (AS) 770. The 5G NAS 720 can include communication connections with both a 5G AS 740 and a non-3GPP AS 730 and Wi-Fi AS 732. The 5G NAS 720 can include functional entities associated with both access stratums. Thus, the 5G NAS 720 can include multiple 5G MM entities 726 and 728 and 5G session management (SM) entities 722 and 724. The legacy NAS 750 can include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 can include functional entities such as LTE AS 772, Universal Mobile Telecommunications Service (UMTS) AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM can maintain individual connection management and registration management state machines for each connection. Additionally, a device (e.g., UE 106) can register to a single PLMN (e.g., 5G CN) using 5G cellular access as well as non-cellular access. Further, it can be possible for the device to be in a connected state in one access and an idle state in another access and vice versa. Finally, there can be common 5G-MM procedures (e.g., registration, de-registration, identification, authentication, as so forth) for both accesses.

Note that in various embodiments, one or more of the above described functional entities of the 5G NAS and/or 5G AS can be configured to perform methods overhead reduction for multi-carrier beam selection and power control, e.g., as further described herein.

### Overload and Congestion Control

As 3GPP progressed, mechanisms were introduced for overload and congestion control. In some examples, such overload and congestion control can be used to address strain on the network associated with expanded use of Machine Type Communication (MTC) and Cellular Internet of Things (CIoT) related devices. For example, the network can have received too many requests from devices which resulted in congestion or an overload situation. Accordingly, one mechanism that was proposed to alleviate overload and/or congestion on the network (NW) side was for the NW to reject the UE's requests for signaling and/or data and assign a “back-off timer” to the UE. This timer maintained by the UE would specify a duration in which the UE was not allowed any retry attempts (e.g., transmission of additional requests for signaling and/or data) excluding particular high priority scenarios (e.g., emergency call requests, respond to paging requests, etc.). In some instances, while UEs transmitting paging responses or emergency requests to the NW can possibly not be rejected, UEs requesting resources for mobile originated signaling or mobile originated data can be rejected by the NW.

In some instances, the back-off timer could be at the Mobility Management (MM) or Session Management (SM) of the NAS layer. For example, the MM back-off timer was characterized as “T3346” (e.g., a T3346 timer) and it was specified that once a UE was rejected by the NW and had received an MM back-off timer, the timer would also apply in other systems. For example, if the UE received an MM timer in 4G, it would also apply to the packet switched (PS) domain of the legacy (2G/3G) NWs, and vice versa. In some embodiments, the MM layer can be involved in registration procedures and establishing a link between devices and the network. Additionally, the MM layer can be involved with security features such as authentication and identification of devices, according to some embodiments. For example, the back-off timer (e.g., T3346) can have been sent by the NW to the UE along with a rejection Cause Value (e.g., Cause #22), which indicated congestion at the NW side.

Additionally, there were also scenarios in which the mobility anchor in the Core NW (e.g., the mobility management entity (MME)) would be overloaded. In this scenario, the MME could send an “Overload Start” message to the radio access network (RAN) (e.g., to an eNB) and indicate to reject connection establishment requests at the radio layer (e.g., at the RRC layer), for certain establishment causes (e.g., cause values or cause codes that reflect the reason for UE's access requests). Furthermore, some establishment cause parameters can be included connection requests to inform the network of a reason for establishing a connection. For example, higher priority establishment causes or reasons can be related to emergency calls or paging responses. Alternatively, some lower priority establishment causes or reasons can be from devices that are tolerant to delays (e.g., delay tolerant) due to their use case and/or environment. For example, a sensor in a home (e.g., a video doorbell, etc.) can be considered lower priority by the network since it is delay tolerant.

In addition, a new timer characterized as an “Extended Wait Time (EWT)” was defined at the RRC layer and was proposed to be sent to the UE. In some embodiments, the EWT can correspond to a time value or duration of up to thirty minutes (as one example). Therefore, this meant that when a UE sent an RRC Connection Request to the RAN, it would receive an RRC Connection Reject message including an EWT. For example, the EWT can indicate an amount of time that the network can prefer (and is therefore indicating) not to receive signaling from the UE. More specifically, the UE receives the EWT via the RAN (e.g., from the eNB via RRC signaling) rather than from a core network (CN) entity. Once the UE received this EWT timer, the RRC layer of the UE should then pass the EWT to the NAS (EPS mobility management (EMM)) layer. Once the EWT has been communicated from the RRC layer to the NAS layer, the EMM protocol at the UE side should then start a T3346 timer with a value equal to the EWT and consider itself backed-off from EMM signaling. Accordingly, this resulted in the UE not performing any mobility management signaling in the legacy NWs (e.g., 3G) for the duration of the T3346 timer.

With the proliferation of 5G, various scenarios involving transitions between 5G and 4G have emerged. For example, one scenario can involve a UE registering successfully in 5G. However, due to the UE's mobility or loss of signal, the UE can at some point in time lose 5G coverage and transition to a 4G network. Additionally or alternatively, UEs can periodically undergo internal software (SW) update procedures in which it can lose its connection with the NW. For example, the UE can prompt the user to initiate a software update via a Wi-Fi connection and accordingly the UE can internally detach from the 5G NW. For example, the UE can attempt to perform a SW update using a Wi-Fi connection and disabling service with the RAN. This disabling of the connection with the RAN can be due to the SW update needing to turn off, disable, or reboot certain RAN related components or circuitry.

Due to loss of a 5G signal, the UE can perform a search and find 4G coverage. Accordingly, it can synchronize with the 4G cell and attempt to access the 4G cell via a request (e.g., a RRC connection request message). However, if the 4G cell is overloaded or congested, the 4G network can have been instructed by an MME to initiate or start an overload start procedure. For example, the MME can have transmitted an “overload start” message to the eNB of the 4G network to indicate to the eNB that the MME is in an overloaded state, according to some embodiments.

In response to the overload start message and in accordance with appropriate operating procedures, the eNB can transmit a reject message (e.g., a RRC Connection reject message) to the UE. Furthermore, the reject message can include an EWT which can cause the UE to start a T3346 timer with the value (e.g., expiry value) equal to the EWT indicated by the eNB. Accordingly, while the T3346 timer is running, the UE can possibly not be able to perform any additional mobility management signaling to the network. For example, the UE can possibly not be able to benefit from providing tracking area updates or service requests to the network.

Accordingly, and while the T3346 timer is running, the UE can find 5G coverage again and want to inform the 5G NW (e.g., the AMF), of its unavailability. However, since the back-off timer (e.g., T3346=EWT) is running, the UE can possibly not be able to initiate the registration (or deregistration) procedure with the NW. Furthermore, the AMF in which the UE was previously registered can be unaware that the UE has received the EWT in 4G.

Accordingly, there can be additional opportunities to provide enhanced and more flexible overload and congestion control mechanisms for UEs and NW entities. For example, a Seamless UE Context Recovery (SUECR) procedure has been studied in which a UE can inform the core network (CN) (via the AMF) during periods of unavailability. For example, when a UE becomes aware that it will not be available for a particular period of time (e.g., a period of unavailability), it can be beneficial for the UE to inform the NW of this period of unavailability such that the NW can reduce signaling or refrain from signaling the unavailable UE. Accordingly, some measure of power conservation can be realized through said reduction of signaling.

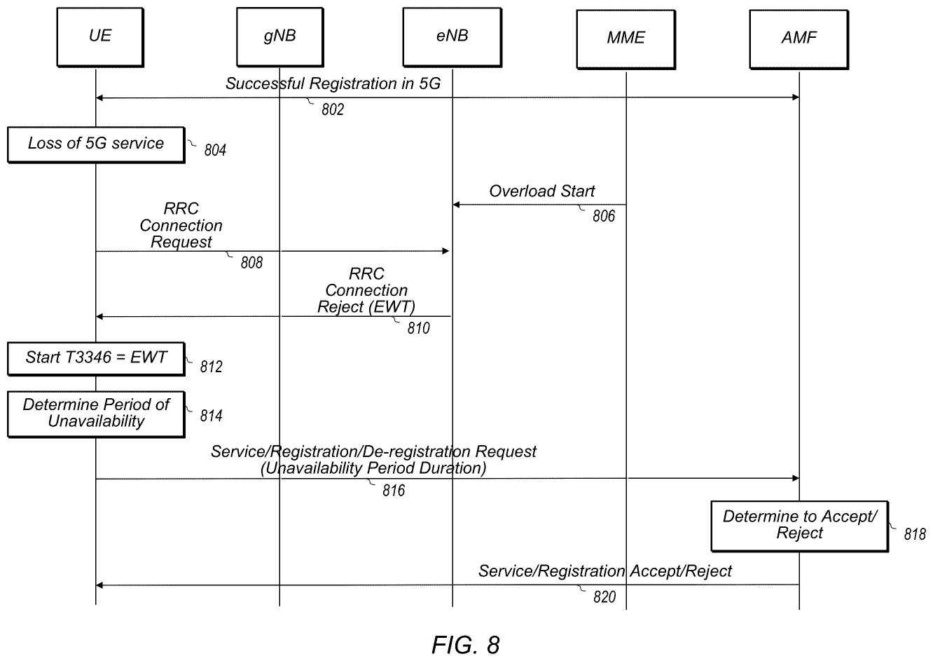

### FIG. 8—Method for Enhanced Overload and Congestion Control

FIG. 8 is a communication flow diagram illustrating example aspects of a method for enhanced overload and congestion control, according to some embodiments.

Aspects of the method of FIG. 8 can be implemented by a wireless device, such as the UE(s) 106, in communication with one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 402, baseband processor(s), processor(s) associated with communication circuitry, etc., among various possibilities) can cause the UE to perform some or all of the illustrated method elements. Note that while at least some elements of the method are described in a manner relating to the use of communication techniques and/or features associated with 3GPP specification documents, such description is not intended to be limiting to the disclosure, and aspects of the method can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method can operate as follows.

At 802, a UE can perform a successful registration procedure in 5G, according to some embodiments. More specifically, the UE can establish a 5G connection associated with a next-generation node-B (gNB) and an AMF. For example, the UE can send a registration request to the 5G core (e.g., the AMF), according to some embodiments. Furthermore, the UE can perform a random access procedure to initiate communication with a gNB and setup an RRC connection with the gNB. Furthermore, the UE can perform NAS level authentication, initiate ciphering for NAS messages with the 5G core, complete an access stratum (AS) security procedure with the gNB, and handle any RRC Reconfiguration messages from the gNB (e.g., setting up a default PDU session or adding secondary cells, as some examples), according to some embodiments. Upon completion of the registration procedure, the UE and 5G NW can communicate via uplink and downlink data flows.

At 804, the UE can lose its 5G connection, according to some embodiments. The UE can, due to UE mobility or loss of signal, lose its 5G connection and service. For example, if the UE moves out of a geographic area that supports a 5G connection to a new area which does not support 5G, the UE can experience a loss of its 5G connection, signal, and/or service. In some instances, the UE can still be in a geographic area that supports 5G but can lose the 5G connection, signal, and/or service due to signal obstructions (e.g., being indoors, being in a RF shielded environment, or being in a valley surrounding by mountains).

At 806, the eNB can receive an overload start message from an MME, according to some embodiments. More specifically, the overload start message can indicate for the eNB to reject registration requests from devices such as the UE. For example, the overload start message sent from the MME to the eNB can indicate that the MME is experiencing congestion or overload due to numerous devices and subsequent numerous communications with the MME which can result in the MME being overloaded or congested. Accordingly, the MME can transmit an overload start message to the eNB to avoid or reduce additional communications from the UE.

At 808, the UE can transmit a connection request to the eNB, according to some embodiments. More specifically, the UE can send an RRC Connection Request message to the eNB in order to connect with a 4G. For example, having lost a previous connection due to UE mobility, loss of signal, the UE can attempt to connect with a 4G network. Accordingly, the UE can transmit RRC signaling in an attempt to connect with a cell of the 4G network.

At 810, the UE can receive a connection reject from the eNB, according to some embodiments. More specifically, the eNB can transmit a RRC connection reject message to the UE. For example, having previously received the overload start message from the MME in 802, the eNB can follow appropriate procedures in response to the overload start message by rejecting connection requests from the UE as well as any other UEs that can attempt to connect. Additionally, as part of the RRC connection reject message, the eNB can include an EWT.

At 812, the UE can start a timer, according to some embodiments. More specifically, the UE can start a T3346 timer equal to the EWT indicated by the eNB. For example, the EWT can be a duration or value of time that the UE should refrain from sending signaling messages to the network. For example, the EWT can be used as an expiry value of the timer in which once that time (e.g., the EWT) has elapsed, the UE can be allowed to send signaling messages to the NW again, according to some embodiments.

At 814, the UE can determine a period of unavailability, according to some embodiments. More specifically, the UE can determine a period in which it (e.g., the UE) will be unavailable (e.g., unreachable) to the network (e.g., the RAN), according to some embodiments. For example, UEs can periodically undergo SW update procedures in which they can lose their connection with the NW. In some embodiments, the SW update procedure can necessitate the disabling of the UE's RAN by turning off, disabling, or rebooting certain RF related components or circuitry. Accordingly, the UE can be able to determine, based on information associated with the SW update, that it will be unavailable for the duration of the SW update. For example, the UE can be able to determine a duration of unavailability (e.g., an unavailability period duration). Additionally, the UE can be able to generate an indication of an “Unavailability Period Duration” to indicate said duration of unavailability, according to some embodiments. Moreover, while the unavailability period duration can be due to scenarios involving SW updates, numerous other scenarios can result in the UE becoming unavailable. Therefore, the methods described herein are not limited to scenarios involving SW updates but can also be applied to other instances in which the UE becomes unavailable or unreachable, according to some embodiments.

At 816, the UE can transmit a request to the AMF, according to some embodiments. More specifically, having found a 5G cell to connect to, the UE can transmit a request to the AMF. According to some embodiments, the 5G cell can belong to a same registration area (RA) that the UE was previously connected to. For example, the UE can find a 5G cell in the same RA it was registered previously. For example, the 5G cell can be in a tracking area (TA) that is in the list of TAs where the UE was previously registered. Accordingly, the UE can attempt to establish an RRC connection with the 5G cell via a request transmission to the AMF. For example, if the new cell that the UE has found in 5G belongs to the same RA where the UE was previously registered, the UE can send a service request message to the AMF. Additionally, if the UE wishes to inform the NW that it will become unavailable for a period of time (e.g., that it will undergo a SW update), the UE can include an indication of “Unavailability Period Duration” in the service request message sent to the AMF. According to some embodiments, the UE can piggyback a Service Request Message on a RRCSetupcomplete message to the AMF. Accordingly, the reception of this message at the AMF including the “Unavailability Period Duration” can indicate that the UE has received an EWT in 4G. For example, it can be beneficial for the UE (being aware that the T3346 timer is running) to signal an unavailability period to the network in order to avoid unnecessary communications (and therefore conserving power) to the unavailable UE.

According to some embodiments, if the new cell that the UE has found in 5G belongs to the same RA where the UE was previously registered, the network can already have information regarding the UE and its previous connection with the network. For example, as the UE was previously registered in the same RA, the network can possibly not need to perform additional operations to re-authenticate and re-verify security parameters (as some examples). For example, since the UE was previously registered in the same RA, the network can be able to more quickly and efficiently communicate with the UE regarding the request due to not having to perform authentication and security procedures again. In another embodiment, the UE can send either a Registration Request or a De-Registration Request to the AMF, including the “Unavailability Period Duration” as well as an indication to the 5G NW (e.g., the AMF) that it has received an EWT in 4G.

Alternatively at 816, if the new cell that the UE has found in 5G does not belong to the same RA where the UE was previously registered, the UE can send a registration request message to the AMF. For example, the 5G cell can be in TA that is not in the list of TAs where the UE was previously registered. Furthermore, the registration request can include the “Unavailability Period Duration” and an indication that it has been backed-off at the RRC layer in 4G, according to some embodiments. This indication could be an information element (IE) added to the message, a flag, or a code-point in the registration type IE, according to some embodiments.

As another alternative at 816, the UE can send a deregistration request message to the AMF including an “Unavailability Period Duration” and an indication that the UE has been backed-off (e.g., rejected) at the RRC layer in 4G. This indication could also be IE added to the message, a flag, or a code-point in a deregistration type IE, according to some embodiments.

As one possibility at 816, the UE can send a non-access stratum (NAS) message indicating that it has been backed-off at the RRC layer in 4G, according to some embodiments. This NAS layer message can also include an indication of the “Unavailability Period Duration” of the UE as an IE added to the message, a flag, or a code-point in a NAS message type IE, according to some embodiments.

At 818, the AMF can determine whether to accept or reject the request from the UE, according to some embodiments. More specifically, once the AMF has been informed at 816 of the period of unavailability and that the UE has been rejected at the RRC layer in 4G, the AMF can need to make a decision or determination of whether to either allow or reject the UE's request, according to some embodiments. The AMF can make this decision based on its own operating load or other various other parameters, according to some embodiments. For example, the AMF can utilize its known operating conditions to make an informed decision regarding whether to accept or reject the UE's request. For example, the AMF can decide to reject a service request from the UE based on the AMF currently experiencing a higher processing load (as one example). Similarly, the AMF can make the decision to reject a registration request for similar reasons. Accordingly, if the AMF decides to reject the service or registration request from the UE, it can also include a new T3346 value determined and/or selected by the AMF. Accordingly, this can reset or override the T3346 timer of the UE.

Alternatively, the AMF can decide to accept a service or registration request from the UE based on the AMF currently experiencing a normal or lower processing load (as one example). Accordingly, as the AMF can determine that it can handle the additional load related to the UE's request, the AMF can decide to accept the UE's request.

At 820, the UE can receive a response message from the AMF, according to some embodiments. More specifically, the AMF can transmit a service accept message, a service reject message, a registration accept message, or a registration reject message depending on the type of request message sent by the UE in 816. Additionally, whether the response is an accept or reject response can be based on the determination or decision made by the AMF in 818. For example, the AMF can decide to transmit a response message (e.g., a service accept, a service reject, a registration accept, a registration reject, or a de-registration accept) to the UE. Accordingly, the UE can then proceed according to appropriate protocol in response to the service or registration accept/reject message received from the AMF.

### Example Embodiments

According to some embodiments, a processor comprising memory storing instructions that, when executed, cause the processor to establish a fifth generation (5G) connection associated with a next-generation node-B (gNB) and an access and mobility function (AMF). Additionally, the processor can generate, for transmission to an enhanced node-B (eNB) and based at least in part on a loss of the 5G connection, a connection request message and receive, from the eNB, a connection reject message. The connection reject message can include an indication associated with a timer expiry value and the processor can start a timer in accordance with the timer expiry value. The processor can further determine a period of unavailability of a user equipment (UE), generate a request message indicating the period of unavailability for transmission to the AMF, and receive a response message from the AMF.

In some embodiments, the connection request message and connection reject message can be radio resource control (RRC) messages. Additionally or alternatively, the request message can be a service request message, a registration request message, or a de-registration request message. Furthermore, the connection reject message from the eNB can be received by the processor at least partially due to a condition of overload or congestion at a mobility management entity (MME).

According to further embodiments, the response message can be transmitted by the AMF based at least in part on a determination made by the AMF and can be a service accept message, a service reject message, a registration accept message, a registration reject message, a de-registration accept message. Additionally or alternatively, the determination can be based on a processing load of the AMF.

In some embodiments, the indication can be an information element (IE) added to the request message, a code-point in a message type IE, or a flag. Additionally or alternatively, the timer can be a T3346 timer and the timer expiry value can be an extended wait time (EWT). In some embodiments, the request message can be for a fifth generation (5G) cell in a same registration area including a cell that the UE was previously connected to. Additionally or alternatively, the response message can include a new timer expiry value determined by the AMF. According to some embodiments, the connection reject message can be received at a radio resource control (RRC) layer of the UE.

In some embodiments, the request message can be for a fifth generation (5G) cell in a second registration area different from a first registration area that includes a cell that the UE was previously connected to. Additionally or alternatively, the request message can be one of a registration request message, a de-registration request message, or a non-access stratum (NAS) message.

In some embodiments, a method can include establishing a fifth generation (5G) connection associated with a next-generation node-B (gNB) and an access and mobility function (AMF). Additionally, the method can include transmitting, based at least in part on a loss of the 5G connection, a connection request message to an enhanced node-B (eNB) and receiving, from the eNB, a connection reject message. The connection reject message can include an indication associated with a timer expiry value and the method can include starting a timer in accordance with the timer expiry value. The method can further include determining a period of unavailability of a user equipment (UE), transmitting a request message indicating the period of unavailability to the AMF, and receiving a response message from the AMF. According to some embodiments, the method can be performed by a non-transitory computer readable storage medium storing program instructions executable by one or more processors to perform the method.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Any of the methods described herein for operating a user equipment (UE) can be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor, comprising:
memory storing instructions that, when executed, cause the processor to:
establish a fifth generation (5G) connection associated with a next-generation node-B (gNB) and an access and mobility function (AMF);
generate, for transmission to an enhanced node-B (eNB) and based at least in part on a loss of the 5G connection, a connection request message;
receive, from the eNB, a connection reject message, wherein the connection reject message comprises an indication associated with a timer expiry value;
start a timer in accordance with the timer expiry value;
determine a period of unavailability of a user equipment (UE);
generate, for transmission to the AMF, a request message indicating the period of unavailability; and
receive, from the AMF, a response message.

2. The processor of claim 1, wherein the connection request message and connection reject message are radio resource control (RRC) messages.

3. The processor of claim 1, wherein the request message is one of:
a service request message,
a registration request message, or
a de-registration request message.

4. The processor of claim 1, wherein the connection reject message from the eNB is received by the UE is at least partially due to a condition of overload or congestion at a mobility management entity (MME).

5. The processor of claim 1, wherein the response message is transmitted by the AMF based at least in part on a determination made by the AMF and is one of:
a service accept message,
a service reject message,
a registration accept message,
a registration reject message, or
a de-registration accept message.

6. The processor of claim 5, wherein the determination is based on a processing load of the AMF.

7. The processor of claim 1, wherein the indication is one of:
an information element (IE) added to the request message,
a code-point in a message type IE, or
a flag.

8. The processor of claim 1, wherein the timer is a T3346 timer and the timer expiry value is an extended wait time (EWT).

9. A method, comprising:
establishing a fifth generation (5G) connection associated with a next-generation node-B (gNB) and an access and mobility function (AMF);
transmitting, based at least in part on a loss of the 5G connection, a connection request message to an enhanced node-B (eNB);
receiving, from the eNB, a connection reject message, wherein the connection reject message comprises an indication associated with a timer expiry value;
starting a timer in accordance with the timer expiry value;
determining a period of unavailability of a user equipment (UE);
transmitting, to the AMF, a request message indicating the period of unavailability; and
receiving, from the AMF, a response message.

10. The method of claim 9, wherein the connection request message and connection reject message are radio resource control (RRC) messages.

11. The method of claim 9, wherein the request message is for a fifth generation (5G) cell in a same registration area including a cell that the UE was previously connected to.

12. The method of claim 11, wherein the request message is one of:
a service request message,
a registration request message, or
a de-registration request message.

13. The method of claim 9, wherein the response message is transmitted by the AMF based at least in part on a determination made by the AMF and is one of:
a service accept message,
a service reject message,
a registration accept message, or
a registration reject message.

14. The method of claim 9, wherein the response message comprises a new timer expiry value determined by the AMF.

15. A non-transitory computer readable storage medium storing program instructions executable by one or more processors to:
establish a fifth generation (5G) connection associated with a next-generation node-B (gNB) and an access and mobility function (AMF);
generate a connection request message for transmission to an enhanced node-B (eNB) based at least in part on a loss of the 5G connection;
receive, from the eNB, a connection reject message, wherein the connection reject message comprises an indication associated with a timer expiry value;
start a timer in accordance with the timer expiry value;
determine a period of unavailability of a user equipment (UE);
generate, for transmission to the AMF, a request message indicating the period of unavailability; and
receive, from the AMF, a response message.

16. The non-transitory computer readable storage medium of claim 15, wherein the connection reject message is received at a radio resource control (RRC) layer of the UE.

17. The non-transitory computer readable storage medium of claim 15, wherein the request message is for a fifth generation (5G) cell in a second registration area different from a first registration area that includes a cell that the UE was previously connected to.

18. The non-transitory computer readable storage medium of claim 17, wherein the request message is one of:
a registration request message,
a de-registration request message, or
a non-access stratum (NAS) message.

19. The non-transitory computer readable storage medium of claim 15, wherein the timer is a T3346 timer and the timer expiry value is an extended wait time (EWT).

20. The non-transitory computer readable storage medium of claim 15, wherein the response message comprises a new timer expiry value determined by the AMF.
